(19) United States
(12) Patent Application Publication
(10) Pub. No.: US 2015/0254407 A1
(43) Pub. Date: Sep. 10, 2015

(54) METHOD AND COMPUTING DEVICE FOR ASSIGNING A DIAGNOSIS CODE

(71) Applicant: McKesson Financial Holdings, Hamilton (BM)

(72) Inventor: Michelle Sporleder, Lohman, MO (US)

(73) Assignee: McKesson Financial Holdings, Hamilton (BM)

(21) Appl. No.: 14/200,984

(22) Filed: Mar. 7, 2014

(51) Int. Cl. G06F 19/00

(52) U.S. Cl. CPC G06F 19/328; G06F 19/322

(57) ABSTRACT

A method, a computing device and a computer program product are provided for associating a diagnosis code, such as an ICD-10 code, with an encounter. In the context of a method, an indication is received that a diagnosis code from a prior encounter is also to be utilized in conjunction with a subsequent encounter. The method further includes determining whether the diagnosis code from the prior encounter is associated with an initial encounter for a respective condition. In an instance in which the diagnosis code from the prior encounter is associated with an initial encounter for the respective condition, the method also determines whether the diagnosis code should be modified to be associated with the subsequent encounter. As such, the method, computing device and computer program product can facilitate the creation of a medical record with accurate diagnosis codes.

### TECHNOLOGICAL FIELD

A method, computing device and computer program product are provided in accordance with an example embodiment in order to assign a diagnosis code and, more particularly, to facilitate selective modification of a diagnosis code from a prior encounter to permit its utilization in conjunction with a subsequent encounter.

### BACKGROUND

During an encounter, such as a patient visit to a doctor's office, a medical care provider generally creates a record of the encounter. In this regard, the record of the encounter created by the medical care provider typically includes one or more diagnosis codes relating to the diagnosis and/or treatment of the patient.

A plurality of diagnosis codes may be predefined such that a medical care provider may select one or more of the predefined diagnosis codes for inclusion in the record of the encounter with the patient. Subsequent to the encounter, a claim may be submitted to a payer, such as an insurance provider, to request payment of the medical provider by the payer. The claim may include the one or more diagnosis codes that were recorded during the encounter such that the payment provided by the payer may be based at least in part upon the one or more diagnosis codes included in the claim. In an instance in which the diagnosis codes included in the claim are inappropriate or otherwise fail to match the record of the encounter, such as diagnosis codes associated with prenatal care for a claim submitted for an elderly gentlemen, the claim may be rejected and payment by the payer to the medical care provider may be delayed or denied.

One type of predefined diagnosis codes is the international classification of diseases (ICD) codes, such as ICD-9 codes and ICD-10 codes. As described above, ICD-9 diagnosis codes are commonly utilized to identify the diagnosis of a patient during an encounter and they are also utilized during billing by being included claim submissions. ICD-10 codes have more recently been introduced and may be used as an alternative to ICD-9 codes. The ICD-10 diagnosis codes may incorporate aspects of the ICD-9 diagnosis codes, but also include additional information. For example, the ICD-10 diagnosis codes may include information regarding the encounter level, such as information regarding whether the encounter is an initial encounter for a particular condition or a subsequent encounter for the same condition, such as a follow up visit. By way of example, some ICD-10 codes may include a suffix that identifies the encounter level, such as by distinguishing the initial encounter from a subsequent encounter for the same condition.

Although ICD-10 codes may provide additional information, ICD-10 codes may provide additional opportunities for incorrect ICD-10 codes to be included in the record of the encounter maintained for a patient and thereafter included in a claim submission. As such, ICD-10 diagnosis codes may correspondingly increase the potential that claims may be delayed or denied as a result of the inclusion of incorrect diagnosis codes if careful attention is not paid to the ICD-10 diagnosis codes entered into the record of a patient by the medical provider.

### BRIEF SUMMARY

A method, a computing device and a computer program product are provided in accordance with an example embodiment in order to increase the likelihood that the correct diagnosis code is associated with an encounter. In this regard, the method, computing device and computer program product promote the inclusion of the correct diagnosis code in the record of an encounter, while permitting the diagnosis code to be entered in an efficient manner, such as by permitting a diagnosis code from a prior encounter to be also utilized in conjunction with a subsequent encounter. In accordance with the example embodiment, however, the method, computing device and computer program product are configured to increase the likelihood that the diagnosis code from a prior encounter that is selected to also be utilized in conjunction with a subsequent encounter is appropriate for use with the subsequent encounter. As such, the records maintained by a medical provider may be more accurate in regards to the diagnosis codes associated with the encounters and the claims submitted with the diagnosis codes may have a greater likelihood of being accurate and, consequently, being paid in a timely manner.

In one embodiment, a method for assigning a diagnosis code, such as an ICD-10 diagnosis code, is provided. The method includes receiving an indication that a diagnosis code from a prior encounter is also to be utilized in conjunction with a subsequent encounter. The method further includes determining whether the diagnosis code from the prior encounter is associated with an initial encounter for a respective condition. In an instance in which the diagnosis code from the prior encounter is associated with an initial encounter for the respective condition, the method also determines whether the diagnosis code should be modified to be associated with the subsequent encounter.

The method of an example embodiment may determine whether the diagnosis code should be modified by causing an alert to be provided that indicates that the diagnosis code is associated with the initial encounter for the respective condition. In an instance in which user input is provided subsequent to the alert, the method of this embodiment also modifies the diagnosis code to be associated with the subsequent encounter. The method of this embodiment may also include receiving an indication of whether the diagnosis code should be associated with the subsequent encounter and, in an instance in which the diagnosis code should be associated with the subsequent encounter, determining one or more candidate diagnosis codes for the respective condition. In this embodiment, the method may also include causing one or more candidate diagnosis codes for the respective condition to be displayed and receiving the user input selecting one of the candidate diagnosis codes to be utilized in conjunction with the subsequent encounter.

In an instance in which the one or more candidate diagnosis codes include only one or more predetermined diagnosis codes associated with the subsequent encounter, the method may modify the diagnosis code to be utilized in conjunction with the subsequent encounter to be a respective one of the predetermined diagnosis codes. In one embodiment, the method may receive the indication that the diagnosis code from the prior encounter is also to be utilized in conjunction the subsequent encounter by receiving the indication that the diagnosis code from a chart level is also to be utilized in conjunction with the subsequent encounter.

In another embodiment, a computing device is provided for assigning a diagnosis code, such as an ICD-10 diagnosis code. The computing device includes processing circuitry configured to receive an indication that a diagnosis code from a prior encounter is also to be utilized in conjunction with a subsequent encounter. The processing circuitry is also configured to determine whether the diagnosis code from the prior encounter is associated with an initial encounter for a respective condition. In an instance in which the diagnosis code from the prior encounter is associated with an initial encounter for the respective condition, the processing circuitry is also configured to determine whether the diagnosis code should be modified to be associated with the subsequent encounter.

The processing circuitry of an example embodiment may be configured to determine whether the diagnosis code should be modified by causing an alert to be provided that indicates that the diagnosis code is associated with the initial encounter for the respective condition and, in an instance in which user input is provided subsequent to the alert, modifying the diagnosis code to be associated with the subsequent encounter. In this embodiment, the processing circuitry may be configured to determine whether the diagnosis code should be modified by receiving an indication of whether the diagnosis code should be associated with the subsequent encounter and, the instance which the diagnosis code should be associated with the subsequent encounter, determining one or more candidate diagnosis code for the respective condition. In this embodiment, the processing circuitry may also be configured to determine whether the diagnosis code should be modified by causing the one or more candidate diagnosis codes for the respective condition to be displayed and receiving the user input selecting one of the candidate diagnosis codes to be utilized in conjunction with the subsequent encounter. The processing circuitry of this embodiment may also be configured to modify the diagnosis code by, in an instance in which the one or more candidate diagnosis codes include only one or more predetermined diagnosis codes associated with the subsequent encounter, modifying the diagnosis code to be utilized in conjunction with the subsequent encounter to be a respective one of the predetermined diagnosis codes. The processing circuitry of an example embodiment may be configured to receive the indication of the diagnosis code from the prior encounter to also be utilized in conjunction with a subsequent encounter by receiving an indication that the diagnosis code from a chart level is also to be utilized in conjunction with the subsequent encounter.

In a further embodiment, a computer program product for assigning a diagnosis code, such as an ICD-10 diagnosis code, is provided with the computer program product including a non-transitory computer readable medium having program code stored thereon that includes program code instructions. The program code instructions are configured, upon execution, to receive an indication that a diagnosis code from a prior encounter is to also be utilized in conjunction with a subsequent encounter. The program code instructions of this embodiment are also configured, upon execution, to determine whether the diagnosis code from the prior encounter is associated with an initial encounter for a respective condition. In an instance in which the diagnosis code from the prior encounter is associated with the initial encounter for the respective condition, the program code instructions of this embodiment may also be configured, upon execution, to determine whether the diagnosis code should be modified to be associated with the subsequent encounter.

The program code instructions that are configured to determine whether the diagnosis code should be modified may include program code instructions configured to cause an alert to be provided that indicates that the diagnosis code is associated with the initial encounter for the respective condition and, in an instance which user input is provided subsequent to the alert, modify the diagnosis code to be associated with the subsequent encounter. In this embodiment, the program code instructions that are configured to determine whether the diagnosis code should be modified may also include program code instructions configured to receive an indication of whether the diagnosis code should be associated with the subsequent encounter and, in an instance in which the diagnosis code should be associated with the subsequent encounter, determine one or more candidate diagnosis codes for the respective condition. The program code instructions of this embodiment that are configured to determine whether the diagnosis code should be modified may also include program code instructions configured to cause the one or more candidate diagnosis code for the respective condition to be displayed and to receive the user input selecting one of the candidate diagnosis codes to be utilized in conjunction with the subsequent encounter. In one embodiment, the program code instructions that are configured to modify the diagnosis code may include program code instructions configured, in an instance in which the one or more candidate diagnosis codes include only one or more predetermined diagnosis codes associated with the subsequent encounter, to modify the diagnosis code to be utilized in conjunction with the subsequent encounter to be a respective one of the predetermined diagnosis codes.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 is a block diagram of a computing device that may be specifically configured in accordance with an example embodiment of the present invention;

FIG. 2 is a flow chart illustrating operations performed, such as by the computing device in FIG. 1, in accordance with an example embodiment of the present invention;

FIG. 3 is an example of a graphical user interface that may be presented by the computing device of FIG. 1 in order to establish a record of an encounter;

FIG. 4 is a graphical user interface that may be presented by the computing device of FIG. 1 that may be utilized to create a record of a subsequent encounter and that may facilitate the selection of a diagnosis code from a prior encounter in accordance with an example embodiment of the present invention;

FIG. 5 is a flow chart illustrating operations performed, such as by the computing device of FIG. 1, in order to determine if a diagnostic code should be modified in accordance with an example embodiment of the present invention;

FIG. 6 is a window that may be presented by the computing device of FIG. 1 in order to solicit user input regarding the modification of a diagnosis code in accordance with an example embodiment of the present invention; and

FIG. 7 is a window that may be presented by the computing device of FIG. 1 that identifies a plurality of candidate diagnosis codes to be utilized in conjunction with a subsequent encounter in accordance with an example embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

A method, a computing device and a computer program product are provided in accordance with embodiments of the present invention in order to assign a diagnosis code, such as in conjunction with the record maintained by the medical provider for an encounter with a patient. In this regard, the method, computing device and computer program product are configured to permit diagnosis codes from a prior encounter to be selected for utilization in conjunction with a subsequent encounter so as to allow for entry of the diagnosis codes in an efficient manner. Although referenced herein as a subsequent encounter, the subsequent encounter may be the current encounter with the patient and is considered to be subsequent relative to the prior encounters with the patient. In order to increase the accuracy of the diagnosis codes and, correspondingly, to increase the likelihood that claims that include the diagnosis codes will be paid in a timely manner, the method, computing device and computer program product of an example embodiment provide for further consideration of a diagnosis code from a prior encounter that is selected for utilization in conjunction with a subsequent encounter to insure that the diagnosis code is appropriate for the subsequent encounter.

In one embodiment, a computing device is provided for assigning a diagnosis code in the context of preparing a medical record, such as by assigning a diagnosis code to be utilized in conjunction with a subsequent encounter based upon the diagnosis code from a prior encounter. Although various types of computing devices may be utilized to assign the diagnosis code, the computing device of an example embodiment may be a personal computer, a laptop computer, a tablet computer, a computer workstation or the like of a medical provider that is creating a record of an encounter with a patient. Alternatively, the computing device may be a server or other network-based computing device that interacts with a computer system of a medical provider in order to perform certain functionalities, such as the assignment of diagnosis codes.

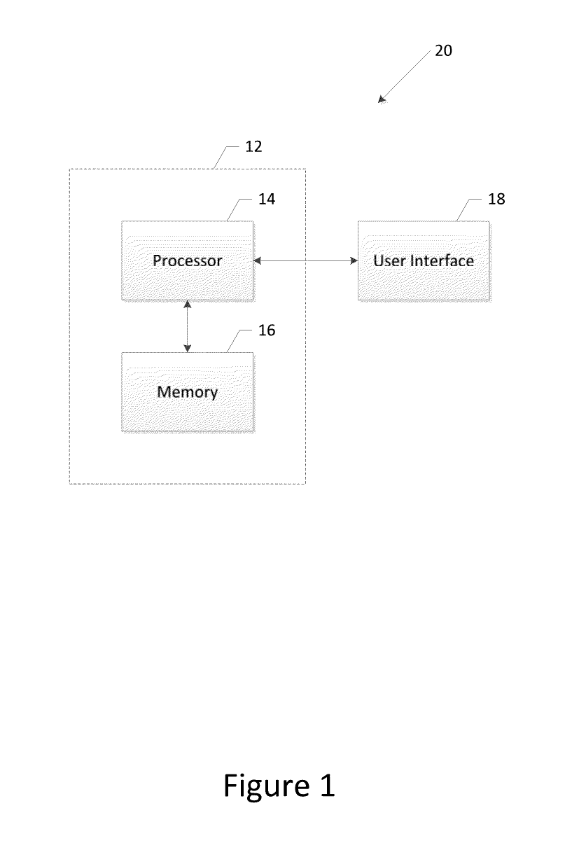

Regardless of the manner in which the computing device is embodied, the computing device 10 of one embodiment may be generally depicted as shown in FIG. 1 so as to include or to be associated and in communication with processing circuitry 12 that is configurable to perform functions in accordance with one or more example embodiments disclosed herein. In this regard, the processing circuitry may be configured to perform and/or control performance of one or more functionalities of the computing device in accordance with various example embodiments, and thus may provide means for performing functionalities of the computing device. The processing circuitry may be configured to perform data processing, application execution and/or other processing and management services according to one or more example embodiments.

In some example embodiments, the processing circuitry 12 may include a processor 14 and, in some embodiments, such as that illustrated in FIG. 1, may further include memory 16. The processing circuitry may be in communication with or otherwise control a user interface 18, such as a display, a keyboard and/or other input/output mechanisms and, in some embodiments, may also include a communication interface for communicating with other computing systems. As such, the processing circuitry may be embodied as a circuit chip (e.g., an integrated circuit chip) configured (e.g., with hardware, software or a combination of hardware and software) to perform operations described herein.

The processor 14 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor may comprise a plurality of processors. The plurality of processors may be in operative communication with each other and may be collectively configured to perform one or more functionalities of the computing device 10 as described herein. The plurality of processors may be embodied on a single computing device or distributed across a plurality of computing devices collectively configured to function as the computing device. In some example embodiments, the processor may be configured to execute instructions stored in the memory 16 or otherwise accessible to the processor. As such, whether configured by hardware or by a combination of hardware and software, the processor may represent an entity (e.g., physically embodied in circuitry—in the form of processing circuitry 12) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform one or more operations described herein.

In some example embodiments, the memory 16 may include one or more non-transitory memory devices such as, for example, volatile and/or non-volatile memory that may be either fixed or removable. In this regard, the memory may comprise a non-transitory computer-readable storage medium. It will be appreciated that while the memory is illustrated as a single memory, the memory may comprise a plurality of memories. The plurality of memories may be embodied on a single computing device or may be distributed across a plurality of computing devices collectively configured to function as the computing device 10. The memory may be configured to store information, data, applications, instructions and/or the like for enabling the computing device to carry out various functions in accordance with one or more example embodiments. For example, the memory may be configured to buffer input data for processing by the processor 14. Additionally or alternatively, the memory may be configured to store instructions for execution by the processor. As yet another alternative, the memory may include one or more databases that may store a variety of files, contents or data sets, such as electronic health records for a plurality of patients. Among the contents of the memory, applications may be stored for execution by the processor in order to carry out the functionality associated with each respective application. In some cases, the memory may be in communication with one or more of the processor or the user interface 18 via a bus or buses for passing information among components of the computing device.

Having now described a computing device 10 configured to implement and/or support implementation of various example embodiments, features of several example embodiments will now be described. It will be appreciated that the following features are non-limiting examples of features provided by some example embodiments. Further, it will be appreciated that embodiments are contemplated within the scope of disclosure that implement various subsets or combinations of the features further described herein. Accordingly, it will be appreciated that some example embodiments may omit one or more of the following features and/or implement variations of one or more of the following features.

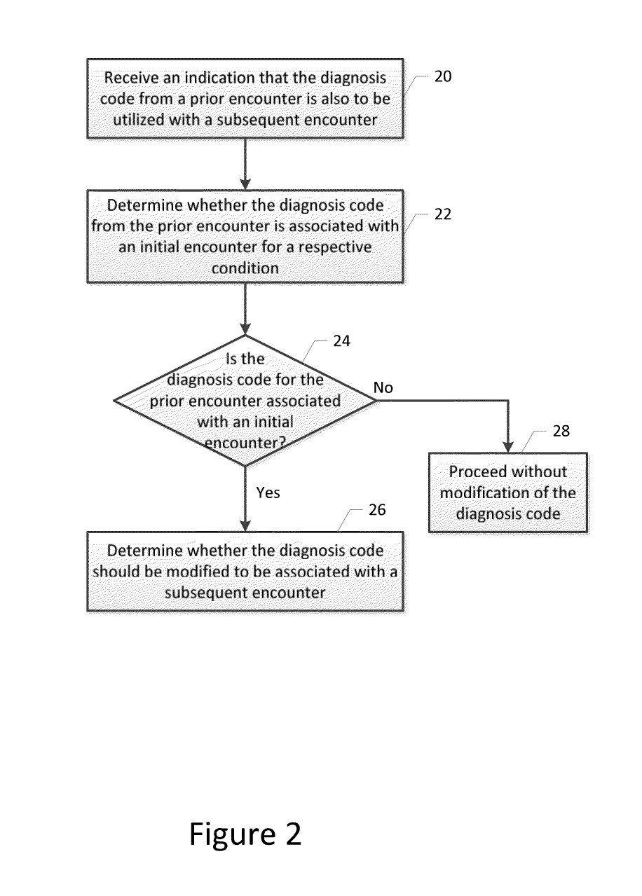

Referring now to FIG. 2, the operations performed, such as by the computing device 10, in order to assign diagnosis codes, are depicted. As shown in block 20 of FIG. 2, the computing device, such as the processing circuitry 12, the processor 14, the user interface 18 or the like, may be configured to receive an indication that the diagnosis code from a prior encounter is also to be utilized in conjunction with a subsequent encounter. While various different types of diagnosis codes may be assigned, the method, computing device and computer program product of an example embodiment will be described hereinafter in conjunction with the assignment of ICD 10 diagnosis codes which are referenced by way of example, but not of limitation. As discussed below, at least some ICD 10 diagnosis codes for the same condition are very similar and differ only in terms of a suffix that is added to identify whether the diagnosis code is associated with an initial encounter or a subsequent encounter for the respective condition.

The computing device 10 may be configured to receive the indication that the diagnosis code from a prior encounter is also to be utilized in conjunction with a subsequent encounter in various manners. In one embodiment, however, the computing device, such as the processing circuitry 12, the processor 14, the user interface 18 or the like, may be configured to receive the indication that the diagnosis code from a chart level, that is, the diagnosis code associated with a prior encounter, is also to be utilized in conjunction with the subsequent encounter.

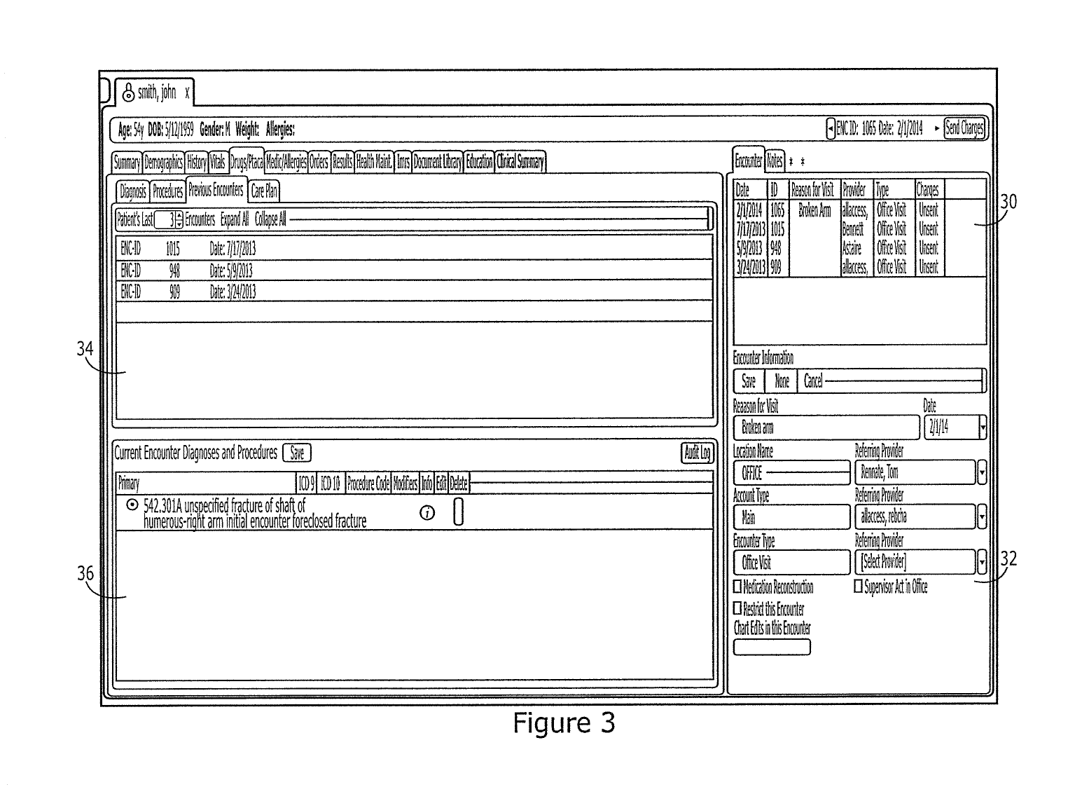

By way of example, a graphical user interface that may be presented by the user interface 18, e.g., the display, of the computing device 10 in order to provide information regarding a patient and prior encounters with the patient as well as to make a record of the current encounter is depicted in FIG. 3. In this regard, the graphical user interface can include a section 30 that identifies the prior encounters and a section 32 that provides information regarding the current encounter, such as the reason for the visit, the name of the location, the referring provider and the like. The graphical user interface of this example embodiment may also include a section 34 that provides information regarding the previous encounters and a section 36 that provides information regarding the current encounter including the diagnosis of the patient and procedures performed upon the patient. In this regard, diagnosis codes associated with the current encounter may be provided such that the resulting record of the encounter that is maintained by the computing device and that may be included in a claims submission will include the diagnosis codes.

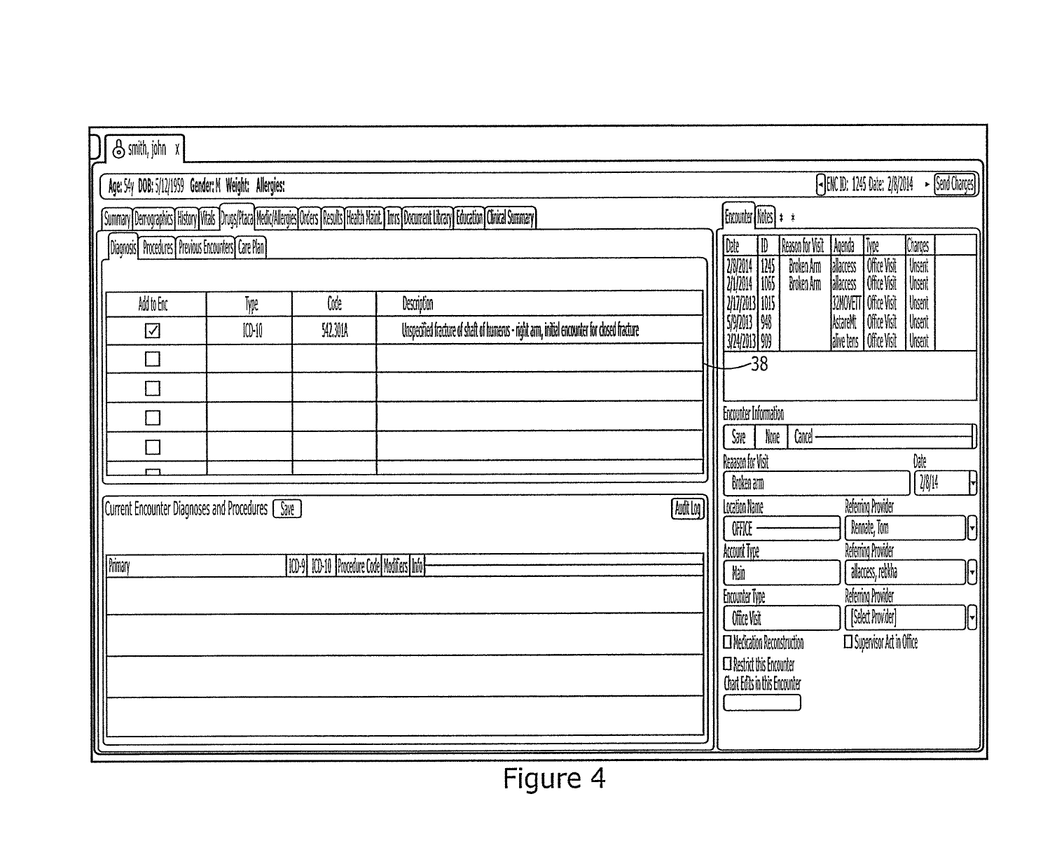

During a subsequent encounter, the computing device 10, such as the processing circuitry 12, the processor 14, the user interface 18 or the like, may provide for receiving an indication that the diagnosis code from a prior encounter is also to be utilized in conjunction with the subsequent encounter as described above in conjunction block 20 of FIG. 2. As shown in FIG. 4, for example, the graphical user interface that may be presented by the user interface, e.g., the display, of the computing device during the subsequent encounter with the patient is depicted. As shown, the graphical user interface may include a listing 38 of the patient's diagnosis codes from prior encounters. The listing of the diagnosis codes may include the code, a description of the diagnosis and, in some embodiments, the type of the diagnosis code. In order to increase the efficiency with which diagnosis codes are associated with a subsequent encounter, a user, such as a medical provider, may provide an indication, such as by checking or otherwise selecting a box associated with a respective diagnosis code from a prior encounter, that the same diagnosis code should be associated with the subsequent encounter. As such, the record associated with the subsequent encounter can be efficiently constructed utilizing one or more diagnosis codes from a prior encounter without requiring the medical provider to independently re-enter the diagnosis codes in conjunction with the subsequent encounter.

However, the diagnosis code associated with the prior encounter may not always be appropriate for a subsequent encounter; even in instances in which the subsequent encounter relates to treatment of the same condition of the patient since some diagnosis codes may be associated with an initial visit while other diagnosis codes are associated with a subsequent encounter. As such, the computing device 10, such as the processing circuitry 12, the processor 14 or the like, may be configured to determine whether the diagnosis code for the prior encounter is associated with an initial encounter for a respective condition. See block 22 of FIG. 2. In this regard, the computing device, such as the processing circuitry, may be configured to determine whether the diagnosis code from the prior encounter is exclusively associated with an initial encounter or whether the diagnosis code may more generally relate to any encounter for the respective condition.

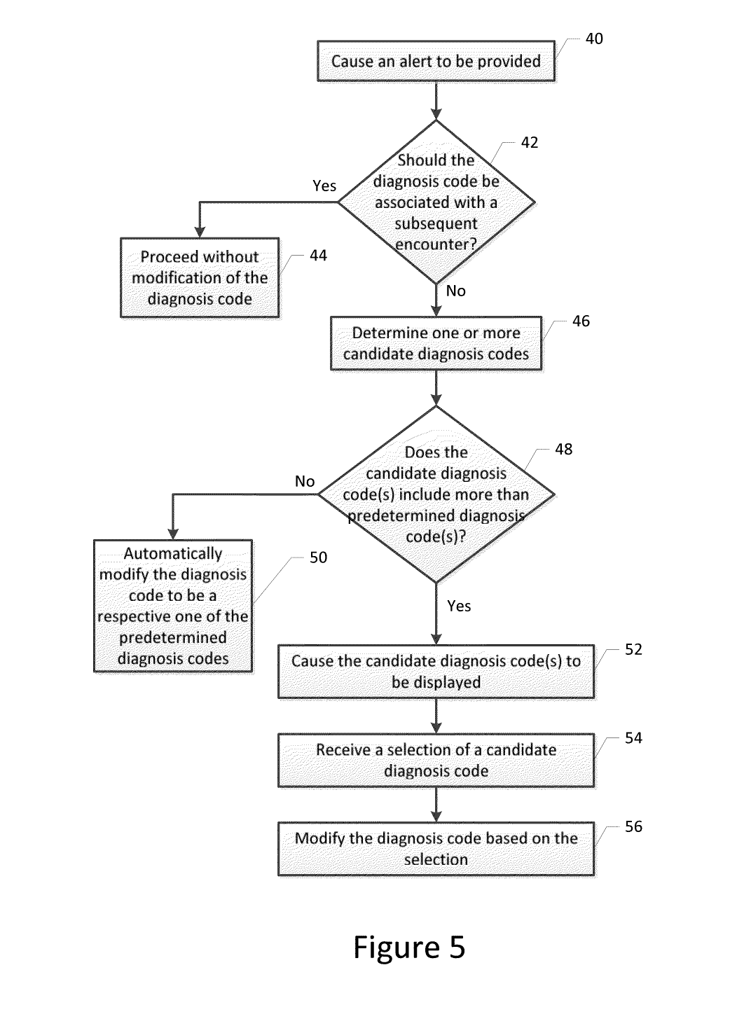

The computing device 10, such as the processing circuitry 12, may be configured to determine whether the diagnosis code is associated with an initial encounter in various manners depending upon, for example, the nature of the diagnosis codes. In regards to ICD 10 diagnosis codes, a suffix may be included that identifies whether the diagnosis code is associated with an initial visit or a subsequent visit. As such, the computing device, such as the processing circuitry, may be configured to evaluate the suffix of the ICD 10 diagnosis code associated with a prior encounter and to determine whether the diagnosis code is associated with an initial encounter, a subsequent encounter or more generally any encounter. As shown in blocks 24 and 26 of FIG. 2, in an instance in which the diagnosis code for the prior encounter is not associated with an initial encounter, such as not being exclusively associated with the initial encounter, the computing device, such as the processing circuitry, may proceed to associate the diagnosis code with the record of the subsequent encounter without modification of the diagnosis code. However, in an instance in which the computing device, such as the processing circuitry, determines that the diagnosis code for the prior encounter is associated with an initial encounter, such as by being exclusively associated with an initial encounter, the computing device, such as the processing circuitry, may be configured to determine whether the diagnosis code should be modified to be associated with a subsequent encounter as shown generally in block 28 of FIG. 2 and, in more detail, in FIG. 5.

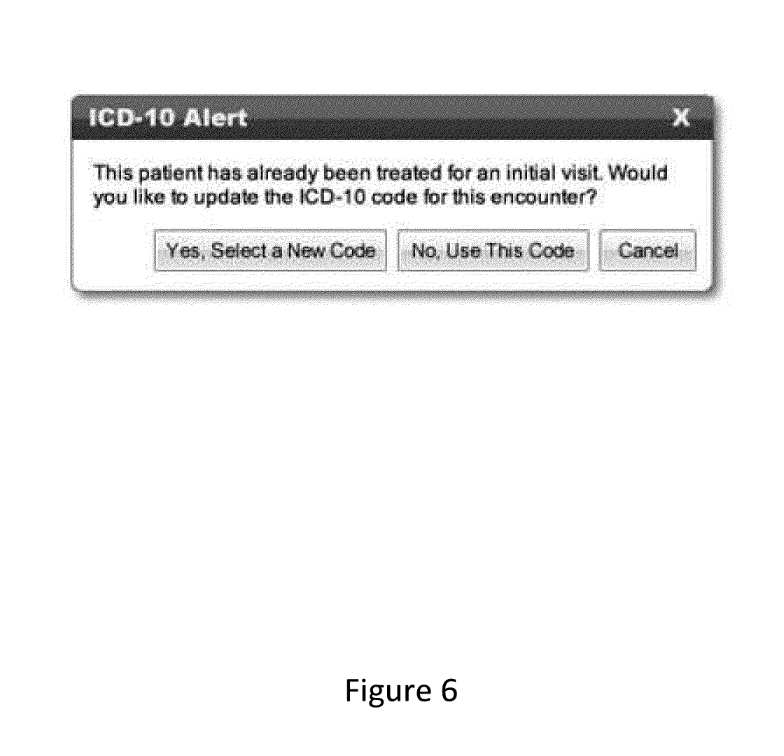

Although the computing device 10 may be configured to determine whether the diagnosis code should be modified to be associated with a subsequent encounter in a variety of different manners, the operations performed by the computing device, such as the processing circuitry 12, of one embodiment in order to determine whether the diagnosis code should be modified to be associated with a subsequent encounter is depicted in FIG. 5. In this regard, in response to a determination that the diagnosis code from the prior encounter is associated with, such as being exclusively associated with, an initial encounter for a respective condition, the computing device, such as the processing circuitry, the processor 14, the user interface 18 or the like, may be configured to cause an alert to be provided that indicates to the user that the diagnosis code is associated with the initial encounter for the respective condition. See block 40 of FIG. 5. The computing device may be configured to provide a variety of alerts. In one embodiment, however, the computing device, such as the processing circuitry, the user interface or the like, may be configured to present an alert upon the display that indicates that the diagnosis code from the prior encounter is associated with the initial encounter for a respective condition, as opposed to a subsequent encounter, such as the current encounter, for the same respective condition. An example of an alert that may be presented upon the display is shown in FIG. 6.

As shown in block 42 of FIG. 5, the computing device 10, such as the processing circuitry 12, the processor 14, the user interface 18 or the like, may be configured to receive an indication as to whether the diagnosis code should be associated with the subsequent encounter. Although the indication may be received in various manners, a computing device of an example embodiment that presents the alert shown in FIG. 6 may receive user input by the selection of a respective button associated with the alert that indicates whether or not the user wishes for the diagnosis code from the prior encounter to be associated with the subsequent encounter. In an instance in which the indication is that the diagnosis code should be associated with a subsequent encounter, the computing device may proceed without modification of the diagnosis code, such as by constructing a record of the current encounter that includes the diagnosis code from the prior encounter, as shown in block 44.

Alternatively, if the indication that is received is that the diagnosis code associated with the prior encounter should not be associated with the subsequent encounter or should be modified prior to being associated with the subsequent encounter, the computing device 10, such as the processing circuitry 12, the processor 14 or the like, may be configured to determine one or more candidate diagnosis codes for the respective condition. See block 46 of FIG. 5. In this regard, the computing device, such as the memory 16, may include a plurality of predefined diagnosis codes associated with respective conditions. In this embodiment, the condition with which the diagnosis code from the prior encounter is associated may be identified and all other diagnosis codes associated with the same condition may be identified by the processing circuitry and may be considered candidate diagnosis codes.

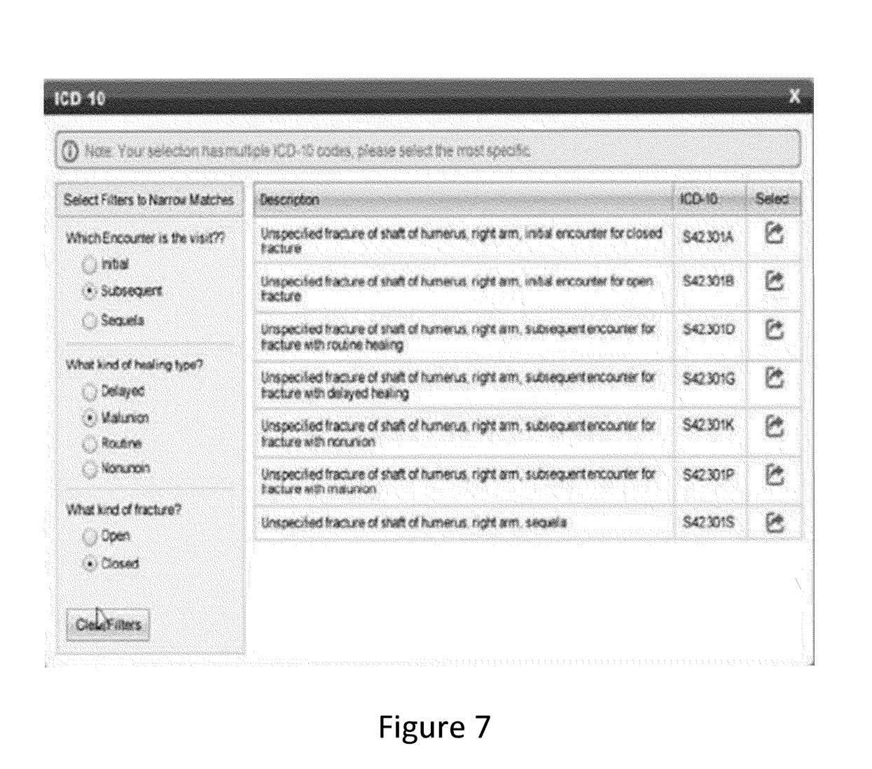

In one embodiment, the computing device 10, such as the processing circuitry 12, the processor 14, the user interface 18 or the like, may be configured to cause the one or more candidate diagnosis codes to be presented, such as upon the display of the computing device. See block 52 of FIG. 5. As shown in FIG. 4, the diagnosis code associated with the prior encounter may have been associated with the fracture of the shaft of the humerus of the right arm of the patient. As such, the computing device, such as the processing circuitry, may determine the other diagnosis codes associated with the fracture of the shaft of the humerus of the right arm and may cause the plurality of diagnosis codes to be presented upon the display as shown in FIG. 7. In response, the computing device, such as the processing circuitry, the processor, the user interface or the like, may be configured to receive user input selecting one of the candidate diagnosis codes to be utilized in conjunction with the subsequent encounter. See block 54. In regards to FIG. 7, for example, the diagnosis code associated with the prior encounter may have been 542.301A for an unspecified fracture of the shaft humerus, right arm, initial encounter for closed fracture, while the diagnosis code as selected for the subsequent encounter may be 542.301D for an unspecified fracture of shaft of humerus, right arm, subsequent encounter for fracture with routine healing. As will be noted, the ICD 10 diagnosis codes of these two diagnosis codes differ only in the suffix of the diagnosis code. However, failure to modify the diagnosis code to be utilized in conjunction with the subsequent encounter and to, instead, rely only upon the diagnosis code from the prior encounter may not only cause the medical record of the patient to be inaccurate, but may also delay payment of a medical provider as the diagnosis code of S42.301A would be improper for a subsequent or follow up visit.

As such, the computing device 10, such as the processing circuitry 12, the processor 14 or the like, may be configured to modify the diagnosis code that is to be utilized in conjunction with the subsequent encounter based upon the selection of a candidate diagnosis code. See block 56 of FIG. 5. In this regard, the diagnosis code to be associated with the subsequent encounter may be changed from the diagnosis code associated with the prior encounter to the candidate diagnosis code that is selected by the user. The resulting medical record of the patient may therefore be more accurate and the likelihood of being paid by a payer, such as an insurance provider, in a timely manner is increased.

In one embodiment, the computing device 10 may evaluate the one or more diagnosis codes prior to presenting the candidate diagnosis codes to the user and soliciting a selection. In this regard, the computing device, such as the processing circuitry 12, the processor 14 or the like, of an example embodiment may determine whether the one or more candidate diagnosis codes includes more than one or more predetermined diagnosis codes. In this regard, one or more of the diagnosis codes associated with a respective condition may be identified as a predetermined diagnosis code(s). In an instance in which the only candidate diagnosis codes are those that are predetermined diagnosis codes, the computing device, such as the processing circuitry, the processor or the like, may automatically modify the diagnosis code to be a respective one of the predetermined diagnosis codes without consultation of the user. See blocks 48 and 50 of FIG. 5. For example, if the only candidate diagnosis code is a candidate diagnosis code associated with a subsequent encounter for the same condition as that with which the diagnosis code for the initial encounter is associated, the computing device, such as the processing circuitry, may be configured to automatically modify the diagnosis code associated with the subsequent encounter to be the predetermined diagnosis code that is associated with a subsequent encounter. Conversely, if the candidate diagnosis codes that are identified include one or more diagnosis codes in addition to those that have been predetermined, the computing device, such as the processing circuitry, may be configured to present the candidate diagnosis codes to the user and to solicit selection of a respective candidate diagnosis code as described above in conjunction with blocks 52-56.

As described above, the method, computing device 10 and computer program product promote the inclusion of the correct diagnosis code in the record of an encounter, while permitting the diagnosis code to be entered in an efficient manner, such as by permitting a diagnosis code from a prior encounter to be also utilized in conjunction with a subsequent encounter. However, the method, computing device and computer program product are also configured to increase the likelihood that the diagnosis code from a prior encounter that is selected to also be utilized in conjunction with a subsequent encounter is appropriate for use with the subsequent encounter. As such, the records maintained by a medical provider may be more accurate in regards to the diagnosis codes associated with the encounters and the claims submitted with the diagnosis codes may have a greater likelihood of being accurate and, consequently, being paid in a timely manner.

As described above, FIGS. 2 and 5 illustrate flowcharts of a method, computing device 10 and computer program product according to example embodiments of the invention. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices 16 of a computing device and executed by processing circuitry 12 in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks or steps of the flowcharts support combinations of means for performing the specified functions and combinations of steps for performing the specified functions. It will also be understood that one or more blocks of the flowcharts, and combinations of blocks in the flowcharts, may be implemented by special purpose hardware-based computer systems which perform the specified functions or steps, or combinations of special purpose hardware and computer program product(s).

The above described functions may be carried out in many ways. For example, any suitable means for carrying out each of the functions described above may be employed to carry out embodiments of the invention. In one embodiment, a suitably configured processing circuitry 12 may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for assigning a diagnosis code, the method comprising:
receiving an indication that a diagnosis code from a prior encounter is to also be utilized in conjunction with a subsequent encounter;
determining, with processing circuitry, whether the diagnosis code from the prior encounter is associated with an initial encounter for a respective condition; and
in an instance in which the diagnosis code from the prior encounter is associated with the initial encounter for the respective condition, determining whether the diagnosis code should be modified to be associated with the subsequent encounter.

2. A method according to claim 1 wherein determining whether the diagnosis code should be modified comprises:
causing an alert to be provided that indicates that the diagnosis code is associated with the initial encounter for the respective condition; and
in an instance in which user input is provided subsequent to the alert, modifying the diagnosis code to be associated with the subsequent encounter.

3. A method according to claim 2 wherein determining whether the diagnosis code should be modified further comprises:
receiving an indication of whether the diagnosis code should be associated with the subsequent encounter; and
in an instance in which the diagnosis code should be associated with the subsequent encounter, determining one or more candidate diagnosis codes for the respective condition.

4. A method according to claim 3 wherein determining whether the diagnosis code should be modified further comprises:
causing the one or more candidate diagnosis codes for the respective condition to be displayed, and
receiving the user input selecting one of the candidate diagnosis codes to be utilized in conjunction with the subsequent encounter.

5. A method according to claim 3 wherein modifying the diagnosis code comprises, in an instance in which the one or more candidate diagnosis codes include only one or more predetermined diagnosis codes associated with the subsequent encounter, modifying the diagnosis code to be utilized in conjunction with the subsequent encounter to be a respective one of the predetermined diagnosis codes.

6. A method according to claim 1 wherein the diagnosis code comprises an ICD10 diagnosis code.

7. A method according to claim 1 wherein receiving the indication comprises receiving an indication that the diagnosis code from a chart level is also to be utilized in conjunction with the subsequent encounter.

8. A computing device for assigning a diagnosis code, the computing device comprising processing circuitry configured to:
receive an indication that a diagnosis code from a prior encounter is to also be utilized in conjunction with a subsequent encounter;
determine whether the diagnosis code from the prior encounter is associated with an initial encounter for a respective condition; and
in an instance in which the diagnosis code from the prior encounter is associated with the initial encounter for the respective condition, determine whether the diagnosis code should be modified to be associated with the subsequent encounter.

9. A computing device according to claim 8 wherein the processing circuitry is configured to determine whether the diagnosis code should be modified by:
causing an alert to be provided that indicates that the diagnosis code is associated with the initial encounter for the respective condition; and
in an instance in which user input is provided subsequent to the alert, modifying the diagnosis code to be associated with the subsequent encounter.

10. A computing device according to claim 9 wherein the processing circuitry is configured to determine whether the diagnosis code should be modified by:
receiving an indication of whether the diagnosis code should be associated with the subsequent encounter; and
in an instance in which the diagnosis code should be associated with the subsequent encounter, determining one or more candidate diagnosis codes for the respective condition.

11. A computing device according to claim 10 wherein the processing circuitry is configured to determine whether the diagnosis code should be modified by:
causing the one or more candidate diagnosis codes for the respective condition to be displayed, and
receiving the user input selecting one of the candidate diagnosis codes to be utilized in conjunction with the subsequent encounter.

12. A computing device according to claim 10 wherein the processing circuitry is configured to modify the diagnosis code by, in an instance in which the one or more candidate diagnosis codes include only one or more predetermined diagnosis codes associated with the subsequent encounter, modifying the diagnosis code to be utilized in conjunction with the subsequent encounter to be a respective one of the predetermined diagnosis codes.

13. A computing device according to claim 8 wherein the diagnosis code comprises an ICD10 diagnosis code.

14. A computing device according to claim 8 wherein the processing circuitry is configured to receive the indication by receiving an indication that the diagnosis code from a chart level is also to be utilized in conjunction with the subsequent encounter.

15. A computer program product for assigning a diagnosis code, the computer program product comprising a non-transitory computer readable medium having program code stored thereon, the program code comprising program code instructions configured, upon execution, to:
receive an indication that a diagnosis code from a prior encounter is to also be utilized in conjunction with a subsequent encounter;
determine whether the diagnosis code from the prior encounter is associated with an initial encounter for a respective condition; and
in an instance in which the diagnosis code from the prior encounter is associated with the initial encounter for the respective condition, determine whether the diagnosis code should be modified to be associated with the subsequent encounter.

16. A computer program product according to claim 15 wherein the program code instructions configured to determine whether the diagnosis code should be modified comprise program code instructions configured to:
cause an alert to be provided that indicates that the diagnosis code is associated with the initial encounter for the respective condition; and
in an instance in which user input is provided subsequent to the alert, modify the diagnosis code to be associated with the subsequent encounter.

17. A computer program product according to claim 16 wherein the program code instructions configured to determine whether the diagnosis code should be modified further comprise program code instructions configured to:
receive an indication of whether the diagnosis code should be associated with the subsequent encounter; and
in an instance in which the diagnosis code should be associated with the subsequent encounter, determine one or more candidate diagnosis codes for the respective condition.

18. A computer program product according to claim 17 wherein the program code instructions configured to determine whether the diagnosis code should be modified further comprise program code instructions configured to:
cause the one or more candidate diagnosis codes for the respective condition to be displayed, and
receive the user input selecting one of the candidate diagnosis codes to be utilized in conjunction with the subsequent encounter.

19. A computer program product according to claim 17 wherein the program code instructions configured to modify the diagnosis code comprise program code instructions configured, in an instance in which the one or more candidate diagnosis codes include only one or more predetermined diagnosis codes associated with the subsequent encounter, to modify the diagnosis code to be utilized in conjunction with the subsequent encounter to be a respective one of the predetermined diagnosis codes.

20. A computer program product according to claim 15 wherein the diagnosis code comprises an ICD10 diagnosis code.
